(19) United States
(12) Patent Application Publication
(10) Pub. No.: US 2005/0218629 A1
(43) Pub. Date: Oct. 6, 2005

(54) Collapsible and portable sled for transporting game

(76) Inventor: Freddie L. Stacy, Fenton, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/815,915

(22) Filed: Apr. 1, 2004

(51) Int. Cl. B62B 9/04

(52) U.S. Cl. 280/639

(57) ABSTRACT

A collapsible and portable sled apparatus including a first extending ski and a second spaced apart and parallel extending ski. A plurality of crosswise extending members interconnect the first and second skis, each of the crosswise members including overlapping and interengaging portions. A support structure is disposed between the crosswise extending members and each of the first and second skis, the crosswise members defining a load supporting platform between the skis. The sled apparatus is further separated into front and rear attachable sections and the individual pairs of interengaging portions are further capable of being converted from a first engaged and use position, such as by spatially displacing relative to one another and being folded to a second disengaged and collapsed position in which the skis are spaced more closely together.

### BACKGROUND OF THE INVENTION

1. Field of the Invention

The present invention relates generally to towable or trailerable sled devices and the like. More specifically, the present invention discloses a collapsible and portable sled apparatus, particularly useful for transporting deer carcasses and the like upon snow and ice covered surfaces.

2. Description of the Prior Art

The prior art is well documented with various examples of towable and/or trailerable sled apparatus. A first example of this is set forth in U.S. Pat. No. 4,294,457, issued to Thiboutot, and which teaches a collapsible support device for a folding sled having a pair of collapsible ski portions.

The support structure, in an erect position, has two vertical members interconnected at their bottoms by a collapsible, preferably horizontal, member. Each end of the horizontal member is also pivotally connected to the other vertical member by a diagonal support member that extends between each end of the horizontal member and an upper portion of the opposite vertical member. When the structure is erected, the diagonal support members form a substantially “X” shape.

Stiffening members, which are preferably generally vertical, are spaced from the vertical members and extend between the horizontal member and the diagonal support members. Both the horizontal member and the diagonal support members are formed of a plurality of pivotally interconnected links, at least one of which is modified to maintain the links in a desired angular position when the support structure is erected. A diagonal brace member interconnects each of the runners with the vertical support members not pivotally connected thereto. Collapse of the support structure moves the runners and the vertical members towards each other to reduce the width of the structure.

U.S. Pat. No. 3,912,290, issued to Rich, teaches a collapsible sled having a plurality of end aligned and elongated sled sections pivotally secured together at their adjacent ends for relative angular displacement about horizontal transverse axes between a first operative position, with the sections in end aligned position, and a second relatively folded position, with the sled sections disposed in vertically stacked relation. A plurality of spaced apart and fixed transverse extending brackets are provided for separating individual ski members associated with the sled sections.

U.S. Pat. No. 2,472,920, issued to Peenstra, teaches a folding sled having front and rear sections cross-sectionally foldable and collapsible. A back rest support is pivotally associated between the front and rear sections and is adapted to be folded in substantially one operation compactly into flat form for easy carrying and convenient storage in a small space.

U.S. Pat. No. 4,561,665, issued to McFrisby, teaches a collapsible sled apparatus and method of constructing, particularly for use in carrying game and which includes a pair of box-like sections within which there are pivotally mounted pairs of runners. The runners can be placed completely within the box-like sections for transport, and the latter sections closed upon each other to form a complete box with the runners within the box.

U.S. Pat. No. 4,573,695, issued to Kennel, teaches a sled apparatus including a body supporting portion, a runner portion, a runner supporting portion and a steering portion. The body supporting portion includes an elongated frame section with rigid longitudinal edges and front and rear ends. The frame section includes two generally quadrangular members disposed in an end-to-end relationship and pivotally connected to one another. The runner portion includes a runner disposed below and spaced from each longitudinal edge of the frame section, each runner including forward and rear runner sections selectively connectable in an end-to-end relationship when the quadrangular members are disposed in a single plane.

Yet additional examples of prior art sled devices include U.S. Design Pat. No. 400,475, issued to Parker, and which teaches a scissor-type and foldable frame, having widthwise extending bands or supports, and upon which are supported a pair of lengthwise extending and spaced apart skis. Finally, U.S. Design Pat. No. 287,111, issued to Walker, teaches a deer and elk sleigh including a substantially flattened and rectangular shaped mat, from a forward end of which extends a pair of shoulder supporting straps for dragging the game.

### SUMMARY OF THE PRESENT INVENTION

A collapsible and portable sled apparatus, which is capable of being carried and quickly assembled such as in an outdoor location, for transporting such as a deer carcass or the like. The collapsible and portable sled apparatus includes a first extending ski and a second spaced apart and parallel extending ski.

A plurality of crosswise extending members interconnect the first and second skis, each of the crosswise members including overlapping and interengaging portions. A support structure is disposed between the crosswise extending members and each of the first and second skis, the crosswise members defining a load supporting platform between the skis.

The sled apparatus is further separated into front and rear attachable sections, in a preferred embodiment, and the individual pairs of interengaging portions are further capable of being converted from a first engaged and use position, such as by spatially displacing relative to one another and being folded to a second disengaged and collapsed position in which the skis are spaced more closely together. A carrying tote or bag may be employed for storing the disassembled and collapsed front and rear subsections until needed.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the collapsible and portable sled according to the present invention;

FIG. 2 is an exploded view of the individual front and rear sections associated with the sled illustrated in FIG. 1;

FIG. 3 is a side view illustration of the sled shown in FIG. 1;

FIG. 4 is a succeeding top view illustration of the sled shown in FIGS. 1 and 3;

FIG. 5A is first cutaway view taken along line 5A-5A of FIG. 4 and illustrating a pair of interconnecting crosswise extending members in a first engaged position;

FIG. 5B is a succeeding illustration to FIG. 5A and showing the crosswise extending members in a disengaged position;

FIG. 6 is an exploded illustration of the front and rear sled sections illustrated in FIG. 2, and shown in axially collapsed condition; and

FIG. 7 is an environmental illustration of the collapsed sled sections of FIG. 6 carried within a user-supported backpack for portability.

### DETAILED DESCRIPTION OF THE PREFERRED EMBODIMENTS

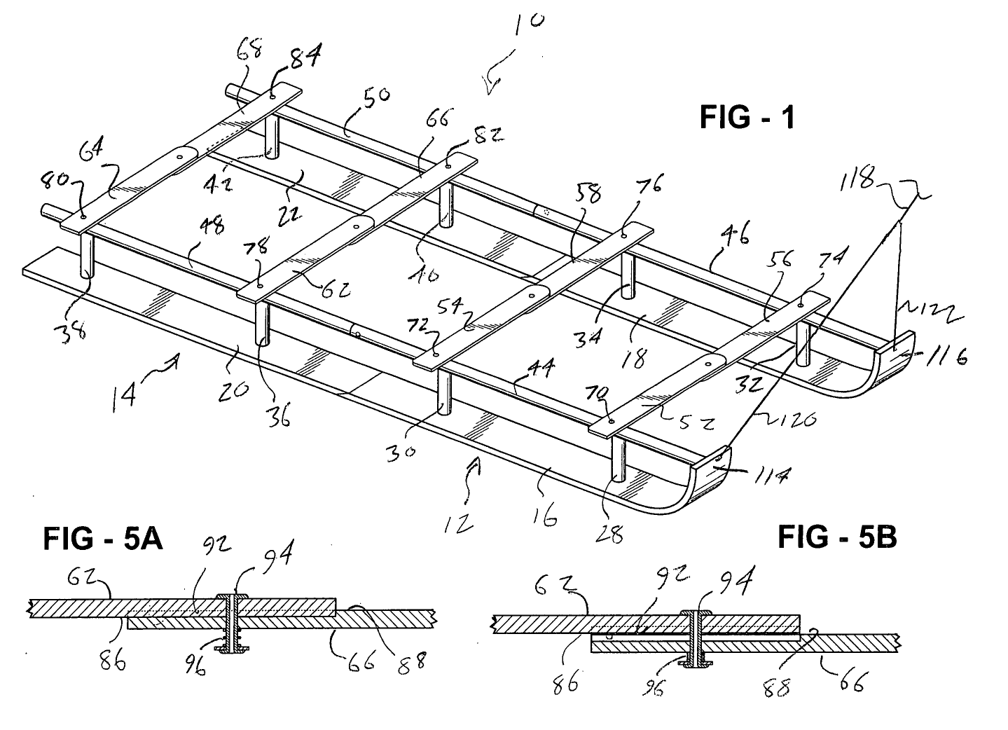

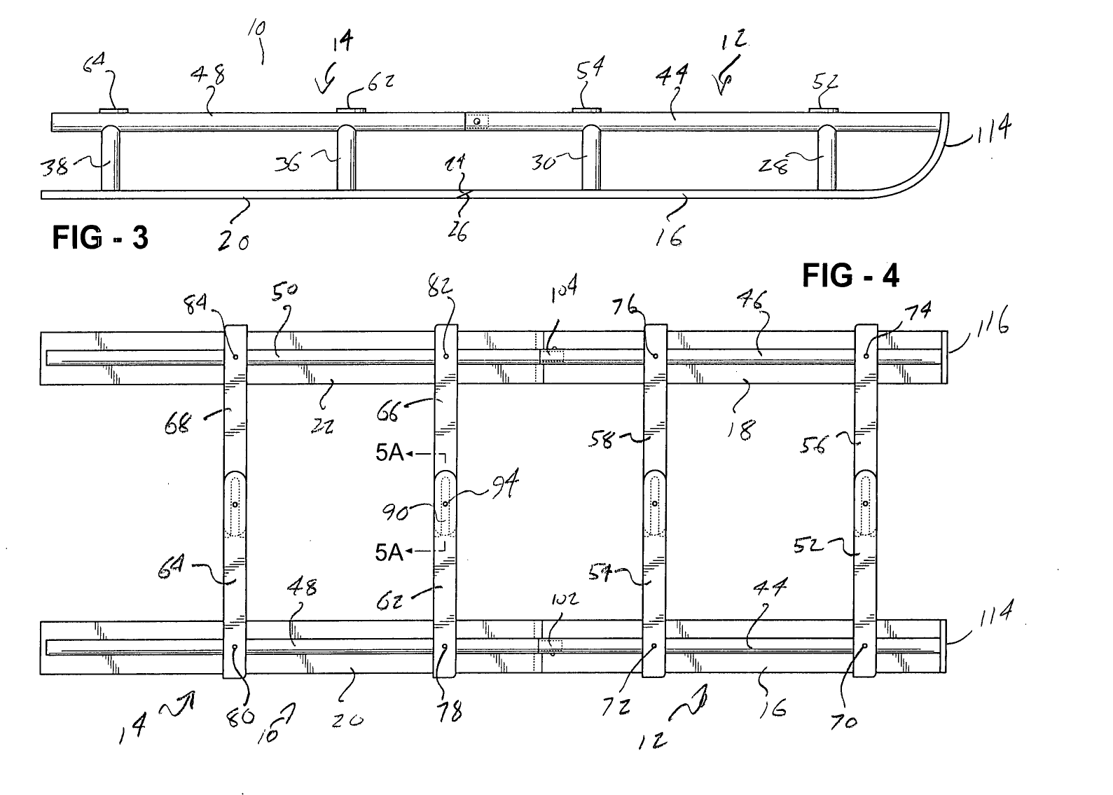

Referring now to each of FIGS. 1-4 and 6, a collapsible sled apparatus is illustrated at 10 according to a preferred embodiment of the present invention. As previously described, the sled apparatus renders possible the ability to portably and efficiently transport a game supporting sled device (such as in particular for deer, elk and like sized animals) and such as within a backpack or other suitable carrying tote.

Referring again to FIG. 1, the sled apparatus 10 is illustrated as including a front section 12 and a separate and interengageable rear section 14. Each of the front 12 and rear 14 sections is constructed of a durable and preferably lightweight material, such including a lightweight steel material or an impact resistant plastic.

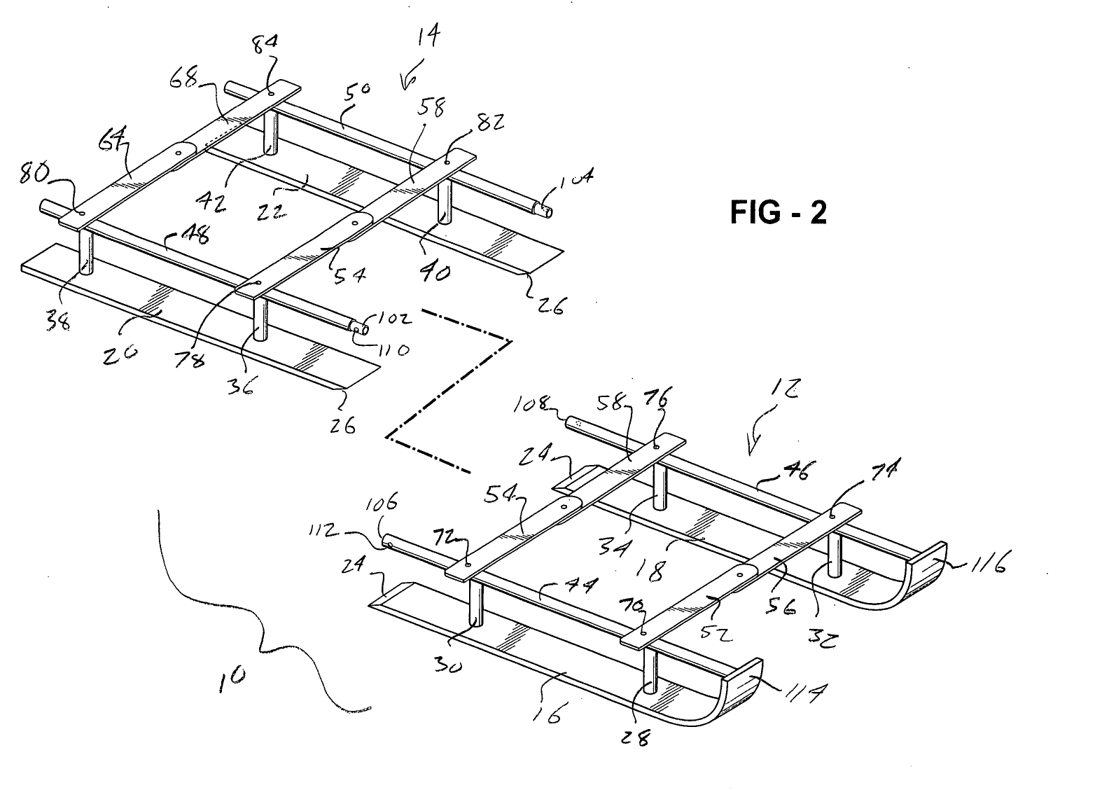

Each of the front 12 and rear 14 sections includes a pair of spaced apart skis, referencing in particular forward ski portions 16 and 18 associated with front section 12 and rearward ski portions 20 and 22. Opposing edges of the forward and rearward ski portions are preferably tapered, such as best illustrated at 24 and 26 respectively in FIG. 2, and facilitate closer mating upon being assembled as shown in FIG. 1.

A support structure is disposed atop the skis and includes preferably vertical and interconnecting horizontal tubular members. In particular, spaced apart and vertically extending members are illustrated for each of the forward and rearward ski portions, referencing in particular vertical portions 28 and 30 for forward ski portion 16, 32 and 34 for other forward ski portion 18, 36 and 38 for rearward ski portion 20 and, finally, at 40 and 42 for other rearward portion 22. Corresponding horizontally extending tubular members are further provided and which are supported atop the vertical members and include members 44 (for vertical supports 28 and 30), 46 (for vertical supports 32 and 34), 48 (for vertical supports 36 and 38) and, finally, 50 (for vertical supports 40 and 42).

Cross members extend between each of the forward 12 and rearward 14 sections and include, in particular, individual pairs of substantially planar shaped and crosswise extending interengaging portions extending from each of the associated forward and rearward ski portions. Specifically, forward section 12 includes spaced apart and crosswise extending portions 52 and 54 associated with horizontal member 44 and interengaging and crosswise extending portions 56 and 58 associated with horizontal member 46. Rearward section 14 includes spaced apart and crosswise extending portions 62 and 64 associated with horizontal member 48, whereas crosswise extending and interengaging portions 66 and 68 are associated with horizontal member-50.

Each of the individual extending and interengaging portions is pivotally associated with its respective horizontal extending member, such as by a pin. This is illustrated by pins 70 and 72 associated with interengaging portions 52 and 54 extending from horizontal member 16, pins 74 and 76 associated with interengaging portions 56 and 58 extending from horizontal member 18, pins 78 and 80 associated with interengaging portions 62 and 64 extending from horizontal member 48 and, finally, pins 82 and 84 associated with interengaging portions 66 and 68 and associated with horizontal member 60.

Referring to FIG. 4, in combination with FIGS. 5A and 5B, cutaway illustration 5A-5A references a selected pair of interengaging portions 62 and 66 associated with the rear section. The collapsing motion of the interengaging portions 62 and 66, as will now be described, is identical to that associated with each other cross member arrangement associated with the front 12 and rear 14 sections of the sled apparatus 10, accordingly a repetitive description of the motion associated with each is not necessary for purposes of ease of illustration and explanation.

Each pair of the substantially plate shaped and elongate extending interengaging portions includes substantially overlapping surfaces, and this is best referenced in the cutaway of FIG. 5A by (downward) surface 86 associated with engaging portion 62 and opposing (upward) surface 88 associated with engaging portion 66. A selected one of the overlapping surfaces 86 and 88 further exhibits an elongate extending projection 90 (see as best shown in phantom 90 in FIG. 4), a corresponding surface associated with the other selected interengaging portion (and such as further by example being referenced by surface 86 of portion 62) further exhibits a mating recess 92 for seating the extending projection 90 in the engaged and use position of FIGS. 1 and 4. To assist in explanation, it should be understood that the cutaway views of FIGS. 5A and 5B do not adequately illustrate the slot shaped and extending recess 90 defined within the overlapped portion of the mating surface 86, in combination with the mating and likewise shaped projection 90, this being understood more readily by reference to the phantom illustration in the overhead view of FIG. 4.

Each pair of the interengaging portions is biasingly pressed together through the effect of a spring loaded pin associated with each of a plurality of pivotal connections. In particular, and referencing again FIGS. 5A and 5B, a pin 94 (also technically described as a bolt, collar or the like) extends through aligning apertures defined in each of the extending and interengaging portions 62 and 66. In a normally engaged and use position (see again in particular FIG. 5A), a coil spring 96 seats about the shaft portion of the pin 94 and against an underside surface of the extending portion 88 in order to bias the portions 62 and 66 together.

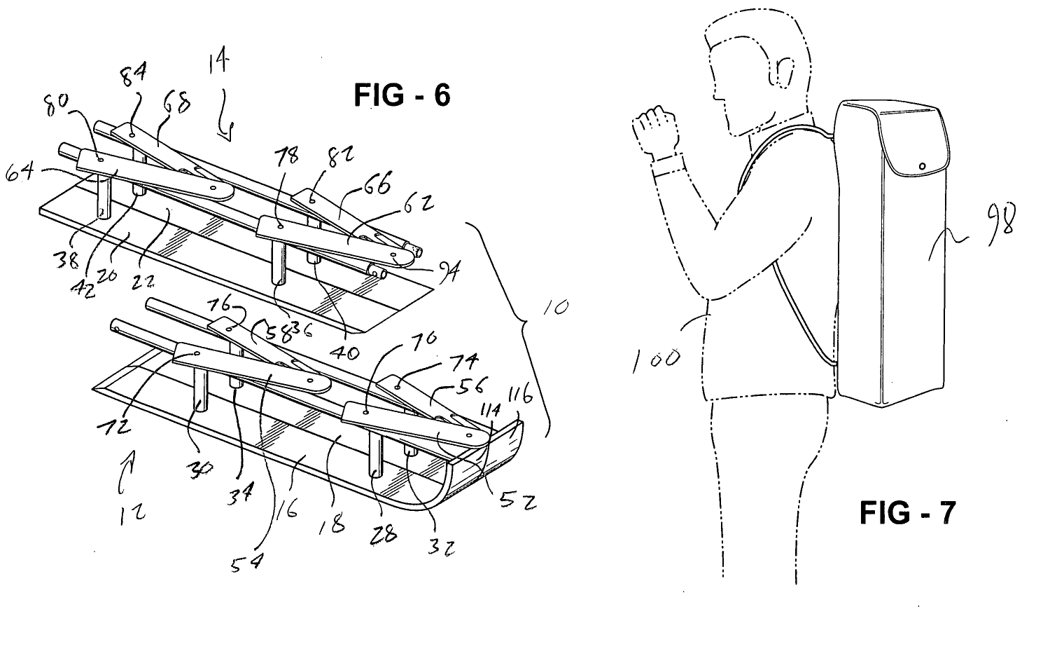

Upon being forcibly dislodged in a direction against one another, and as is further referenced in the succeeding cutaway view of FIG. 5B, the spring 96 is compressed and the projection and recess engagement between the opposing surfaces 86 and 88 is separated. This step is repeated for each interengaging pair of planar shaped portions associated with the front 12 and rear 14 sled sections, at which point the portions are hingedly pivoted, or folded, in a likewise scissors-type motion against each other, see in particular FIG. 6, and such that the ski portions 16 & 18 and 20 & 22 are collapsed into a more closely spaced arrangement relative to each other.

In this fashion, and referencing further FIG. 7, the collapsed sections 12 and 14 are capable of being easily stored within a backpack 98 for carrying by a user 100, such further typically being a hunter. Upon acquiring a deer or other transportable item (not shown), the collapsed sections 12 and 14 (again FIG. 6) are removed from the backpack 98 and are reconverted to the engaged and use position (see FIG. 2).

At this point, connector pins 102 and 104 (see in particular associated with opposing facing ends of horizontal tubular sections 48 and 50 for rearward section 14) are inserted within opposing open ends 106 and 108 to reconfigure and attach the front 12 and rear 14 sections together. As is also illustrated, it is understood that spring loaded bearings or the like (see at 110 for pin 102) can seat within mating side apertures (see further at 112) associated with each open end (shown in FIG. 2 as associated with open end 106 for horizontal member 44) to more securely attach the front and rear sections together. It is also envisioned that other and differently shaped connector plugs can also be incorporated within the scope of the present invention.

Additional features associated with the collapsible sled include a forward extending and upwardly curved end associated with each of the first and second skis (see curved ends 114 and 116 for forward skis 44 and 46) securing to a forward-most extending location associated with each of the forward section horizontally extending members 44 and 46, this being in order to provide further stability to the device. A pull rope, see at 118 in FIG. 1, is attached to one or more locations associated with the forward section 12 of the sled and, preferably, includes subsections 120 and 122 which attach to the upwardly curved ski ends 114 and 116.

Having described my invention, other and additional preferred embodiments will become apparent to those skilled in the art to which it pertains and without deviating from the scope of the appended claims. In particular, the collapsible sled can also be provided with more than two collapsible sections, such as in order to accommodate longer transportable items, or can be provided as a single elongated and non-separable section. Additionally, it is further envisioned that the scissors-type hinged arrangement established between the interengaging portions can be substituted, by example and without limitation, by a telescoping arrangement whereby one of the interengaging ends is slidably engaged within an opposing interengaging end and collapsed inwardly.

1. A collapsible sled apparatus, comprising:
a first extending ski and a second spaced apart and parallel extending ski;
a plurality of crosswise extending members interconnecting said first and second skis, each of said crosswise members including interengaging portions, said crosswise members defining a support platform between said skis; and
said crosswise members being converted between a first engaged and use position and a second disengaged and collapsed position in which said skis are spaced more closely to each other.

2. The collapsible sled apparatus as described in claim 1, further comprising a support structure disposed between said crosswise extending members and each of said first and second skis.

3. The collapsible sled apparatus as described in claim 2, said support structure further comprising at least one vertical member extending from each ski, a horizontally extending member being supported atop said vertical members and to which a selected interengaging portion is attached.

4. The collapsible sled apparatus as described in claim 3, further comprising said skis, support structure and crosswise extending members being separated into a front section and an attachable rear section.

5. The collapsible sled apparatus as described in claim 4, further comprising a pair of connector pins disposed between opposing subsections of said horizontally extending members.

6. The collapsible sled apparatus as described in claim 1, individual pairs of said interengaging portions being pivotally connected together to convert between said use and collapsed positions.

7. The collapsible sled apparatus as described in claim 6, said pairs of interengaging portions each further comprising elongate extending and overlapping surfaces biasingly seating against each other in said engaged and use position.

8. The collapsible sled apparatus as described in claim 7, further comprising a spring-loaded pin associated with each of said pivotally connected portions and biasing together said overlapping surfaces.

9. The collapsible sled apparatus as described in claim 8, said interengaging surfaces being biasingly displaced relative to one another, against a force exerted by said spring-loaded pin, and to effectuate folding of said pairs of interengaging portions to said collapsed position.

10. The collapsible sled apparatus as described in claim 9, an overlapping surface associated with a first of said interengaging portions exhibited by an elongate extending projection, a corresponding surface associated with the other interengaging portion further exhibited by a mating recess for seating said extending projection in said engaged and use position.

11. The collapsible sled apparatus as described in claim 4, further comprising said front and rear sections being supported within a carrying bag in said collapsed position.

12. The collapsible sled apparatus as described in claim 1, said sled apparatus exhibiting a specified shape and size and being constructed of a durable and lightweight steel material.

13. The collapsible sled apparatus as described in claim 1, said sled apparatus exhibiting a specified shape and size and being constructed of a lightweight and impact resistant plastic.

14. The collapsible sled apparatus as described in claim 3, a forward extending and upwardly curved end associated with each of said first and second skis securing to a forward-most extending location associated with each of said horizontally extending members.

15. The collapsible sled apparatus as described in claim 4, each of said skis further comprising tapered mating surfaces established between said front and rear sections.

16. The collapsible sled apparatus as described in claim 1, further comprising a pull rope attached to at least one forward end location associated with said sled apparatus.

17. A collapsible sled apparatus, comprising:
a first extending ski and a second spaced apart and parallel extending ski;
a plurality of crosswise extending members interconnecting said first and second skis, each of said crosswise members including overlapping and interengaging portions;
a support structure disposed between said crosswise extending members and each of said first and second skis, said crosswise members defining a load supporting platform between said skis; and
said interengaging portions being converted from a first engaged and use position, by spatially displacing relative to one another, to a second disengaged and collapsed position in which said skis are spaced more closely to each other.

18. A collapsible sled apparatus, comprising:
a front section and an interengageable rear section;
each of said front and rear sections further comprising:
a first extending ski and a second spaced apart and parallel extending ski
a plurality of crosswise extending members interconnecting said first and second skis, each of said crosswise members including overlapping and interengaging portions; and
a support structure disposed between said crosswise extending members and each of said first and second skis, said crosswise members defining a load supporting platform between said skis;
said interengaging portions being converted from a first engaged and use position, by spatially displacing relative to one another, to a second disengaged and collapsed position in which said interengaging portions are rotated relative to one another and said skis spaced more closely together.
